(19) United States
(12) Patent Application Publication
(10) Pub. No.: US 2009/0037472 A1
(43) Pub. Date: Feb. 5, 2009

(54) INFORMATION PROCESSING APPARATUS AND CONTROL METHOD FOR INFORMATION PROCESSING APPARATUS

(75) Inventor: Toshihiro Morohoshi, Kawasaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/177,618

(22) Filed: Jul. 22, 2008

(30) Foreign Application Priority Data
Jul. 31, 2007 (JP) 2007-199395

(51) Int. Cl. G06F 7/00

(52) U.S. Cl. 707/104.1; 707/E17.009

(57) ABSTRACT

According to one embodiment, a control method for an information processing apparatus includes acquiring metadata in which one or more pieces of meta-information including an address attribute required to download the multimedia data file from a program site are written by using a built-in communication circuit in a main body, detecting a recording format of each multimedia data file written in each piece of meta-information written in the metadata, judging whether the multimedia data file written in each piece of meta-information written in the metadata is reproducible by the reproducing unit based on a recording format detection result, deleting the meta-information having the multimedia data file determined to be unreproducible written therein from the metadata to generate new metadata, and displaying a list of the multimedia data files written in the meta-information included in the new metadata in the display unit.

### CROSS-REFERENCE TO RELATED APPLICATIONS

This application is based upon and claims the benefit of priority from Japanese Patent Application No. 2007-199395, filed Jul. 31, 2007, the entire contents of which are incorporated herein by reference.

### BACKGROUND

1. Field

One embodiment of the present invention relates to an information processing apparatus that has a circuit connected with a network and reproduces a multimedia data file, and a control method for an information processing apparatus.

2. Description of the Related Art

In recent years, there are sites that release multimedia data files, e.g., audio files or video files to the public on the Internet. Some of these sites provide a service called podcasting that releases information of released multimedia data files in the form of data in an RSS format or an Atom format.

In general, a user temporarily receives data of multimedia data files provided by podcasting through a computer and transfers the received data to a portable multimedia player to amuse himself/herself when leaving home.

However, each portable multimedia player is not compatible with files in various recording formats, and reproducible recording formats of files are determined.

JP-A 2002-132595 (KOKAI) discloses a technology that a server converts a file having a recording format which is not compatible with a terminal into a format compatible with each terminal.

Meanwhile, some of recent portable multimedia players have a function enabling connection with a network. In such a portable multimedia player, directly receiving data in an RSS format or an Atom format and displaying information of a file that can be directly downloaded in a display unit can be considered. However, there is data in a recording format that cannot be reproduced by the portable multimedia player as explained above, and a user may possibly erroneously download a file that cannot be reproduced by the player.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing an outline structure of an information processing apparatus according to an embodiment of the present invention;

FIG. 2 is an exemplary front view showing an appearance of the information processing apparatus depicted in FIG. 1;

FIG. 3 is an exemplary view showing a start screen displayed in an LCD;

FIG. 4 is an exemplary view showing a category screen displayed in the LCD;

FIG. 5 is an exemplary view showing a program site list screen displayed in the LCD;

FIG. 6 is an exemplary view showing a program list screen displayed in the LCD;

FIG. 7 is an exemplary view showing a structure concerning a podcasting function of the information processing apparatus depicted in FIG. 1;

FIG. 8 is an exemplary view showing a structure that deletes information of a multimedia data file that can be reproduced by a player 1 from RSS (Atom) data;

FIG. 9 is an exemplary flowchart showing a procedure of processing from download to reproduction of a multimedia data file;

FIG. 10 is a flowchart showing a procedure of processing from download to reproduction of a multimedia data file; and

FIG. 11 is an exemplary flowchart showing a procedure of filtering processing in step S27 depicted in FIG. 10.

### DETAILED DESCRIPTION

Various embodiments according to the invention will be described hereinafter with reference to the accompanying drawings. In general, according to one embodiment of the invention, an information processing apparatus comprises a main body, a display unit provided in the main body, an audio output unit provided in the main body, reproducing unit configured to reproduce a multimedia data file having a specific recording format and output a reproduction signal to at least one of the display unit and the audio output unit, a communication circuit that achieves connection with a network, acquiring unit configured to acquire metadata in which one or more pieces of meta-information including an address attribute to download the multimedia data file from a program site are written by using the communication circuit, format detecting unit configured to detect a recording format of each multimedia data file written in each piece of meta-information written in the metadata, first judging unit configured to judge whether the multimedia data file written in each piece of meta-information written in the metadata is reproducible by the reproducing unit based on a detection result obtained by the format detecting unit, deleting unit configured to generate new metadata obtained by deleting the meta-information having the multimedia data file determined to be unreproducible by the first judgment unit written therein from the metadata, display unit configured to display a list of the multimedia data files written in the meta-information included in the new metadata in the display unit, an operation button configured to select the multimedia data file that is downloaded to the main body based on information of the multimedia data file displayed in the display unit, and downloading unit configured to download multimedia data file selected by the operation button by using the communication circuit.

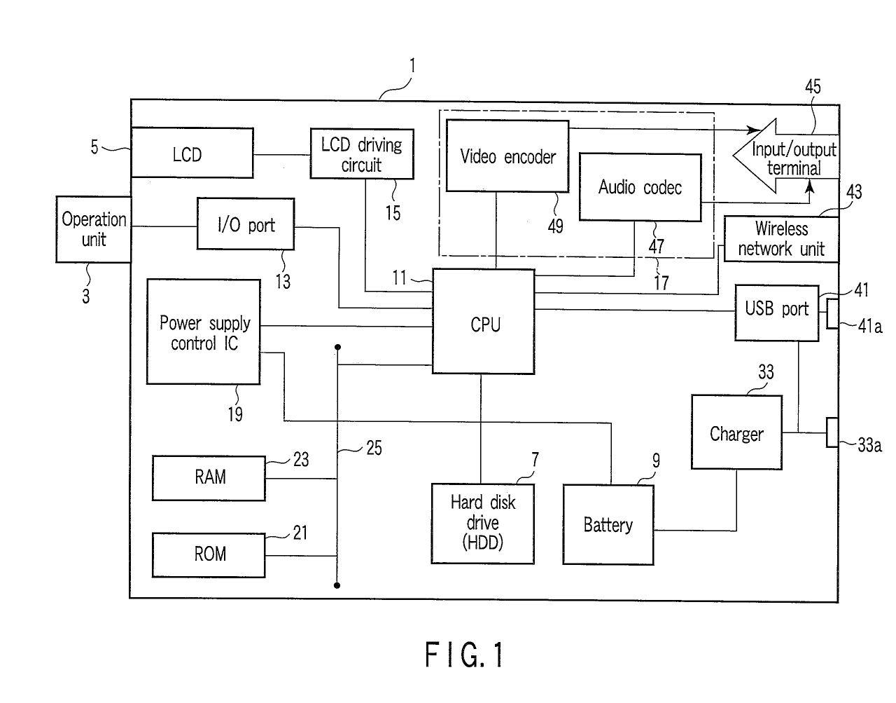

FIG. 1 is a schematic block diagram for explaining primary structures in a media player (an information processing apparatus) to which an embodiment according to the present invention is applied and which is mainly used as a portable device.

A media player (a music/image/video information recording/reproducing apparatus) 1 depicted in FIG. 1 has: an operation unit 3 that is used to input a control signal from a user or input a selection instructing signal: a liquid crystal display device (LCD panel) 5 that can display, e.g., a file name of a currently produced audio/music program, textual information included in an audio program, or a moving image or a still image obtained by reproducing image data; a hard disk drive (HDD) 7 having a storage capacity of, e.g., several gigabytes to several tens of gigabytes; a battery (a secondary battery) 9 as a power supply when the apparatus is mainly used in a portable mode; a CPU 11 as a main controller; and others. It is to be noted that the HDD 7 may be a “mobile disk” formed as a unit detachable from the player 1, an SD/MMC memory card, or a memory stick. The HDD 7 may be a flash drive, a ROM, or a solid-state disk (SSD).

To the CPU 11 are connected an input/output (I/O) port 13 that accepts a control signal input based on an operation of the operation unit 3 by a user, a display driver (an LCD driving circuit) 15 that allows the LCD panel 15 to display an image or a character string that should be displayed, an output unit 17 that converts image data or audio/music data stored in the HDD 7 into an analog output, a power supply control IC (a power management integrated circuit) 19 that manages power supplied from the battery 9, i.e., a predetermined voltage and an allowable current, and others.

A read-only memory (ROM) 21 as a system memory utilized to control, e.g., reproduction of data stored in the HDD 7, recording of data in the HDD 7, activation of the HDD 7, or on/off of a non-illustrated main power supply and a work memory, i.e., a random access memory (RAM) 23 that temporarily stores control information associated with a control signal (input thereto) or a command and buffers a fixed amount of data read out from the HDD 7 are also connected with the CPU 11 through a control bus 25.

The power supply control IC 19 manages power supplied from the battery 9, i.e., a predetermined voltage and an allowable current. The battery 9 is connected with a charger 33. It is to be noted that the charger 33 can be configured to directly accept commercial power (AC 100V) but, in this example, since the player 1 is small in size, a non-illustrated external power supply device inputs a direct-current voltage reduced/converted into a direct current (DC) of approximately 5V from a power supply input unit 33a.

The CPU 11 is also connected with a Universal Serial Bus (USB) port 41 that is a supply source of video data (including character data) or music data (including audio data) and utilized to transmit/receive data to/from, e.g., a personal computer, a wireless network (a wireless local area network) unit (a communication unit) 43, an output terminal 45 utilized for usual analog output, and others.

The USB port 41 is utilized to transfer music data (audio data) from the player 1 to an external device such as an audio exclusive reproduction device (a USB flash memory player) accommodating a semiconductor memory or a USB speaker through an USB connector 41a, or utilized to input a music/audio signal from a microphone (an external input) through the same.

In the wireless network unit 43, it is needless to say that Bluetooth® conforming to a protocol based on a (high-speed) communication standard using an electromagnetic wave in a 2.4-GHz band alone may be provided, or a general-purpose wireless LAN device conforming to IEEE 802.11a/b/g, or both of them may be used. That is, when the wireless LAN device or Bluetooth is incorporated, data can be transmitted/received to/from a server computer or a personal computer placed at home or in a specific range satisfying predetermined conditions.

Music or audio demodulated to an analog signal by an audio codec 47 provided in the output unit 17 is supplied to the output terminal 45 utilized for analog output. Therefore, when a head phone or a speaker with an amplifying function is disposed to the output terminal 45, music or audio is reproduced. Of course, an output from the output terminal 45 can be input to a non-illustrated amplifier, and a non-illustrated speaker can be connected with the amplifier to obtain a large sound volume. It is to be noted that the audio codec 47 can subject an analog signal directly input from a non-illustrated microphone or a line input (an external input) terminal to analog-to-digital conversion to be input as a digital signal.

A video encoder 49 provided in the output unit 17 is also disposed to the output terminal 45. As a result, for example, video data stored in the HDD 7 can be transferred to a non-illustrated monitor device or television set to be reproduced.

In the above-explained media player 1, (contents), e.g., previously compressed music data, image data, or video data are recorded in the HDD 7 in accordance with predetermined rules. It is to be noted that, in regard to compression of data, for example, a format such as MPEG-1 audio layer 3 (MP3) or Windows Media Audio (WMA) is used for compression of music data, a format such as JPEG, GIF, or BMP-RLE is used for compression of image data, and a format such as Windows Media Video (WMV) or MPEG is used for compression of video data, respectively. Further, although not explained in detail, data stored in the HDD 7 can be saved in an encrypted format that allows direct reproduction using the player 1 and output to, e.g., an external speaker in the form of an analog signal alone in order to suppress, e.g., copy excluding that for private use determined by copyright law (excluding copying a fixed number of times).

Reproduction software executed by the CPU 11 reproduces a multimedia data file of, e.g., music data or video data stored in the HDD 7. Recording formats for files that can be reproduced by the reproduction software according to this embodiment are determined, and they are, e.g., MP3, WMA, and WMV.

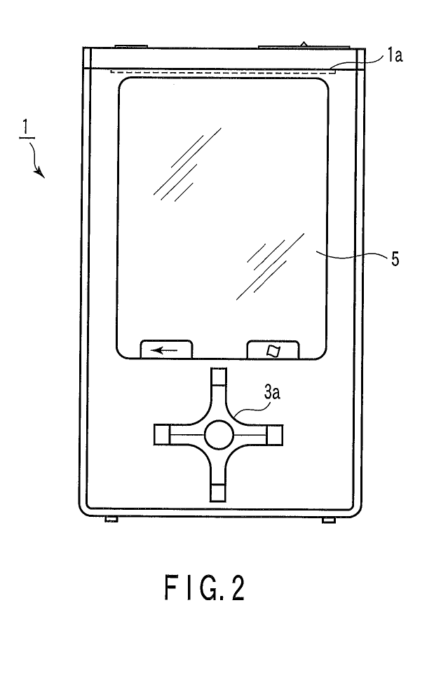

It is to be noted that FIG. 2 shows an appearance of the player 1, and the operation unit 3 includes a multifunction button 3a that is utilized to input control commands for, e.g., instructing to start or stop reproduction of music/image/video, switching information displayed in the LCD 5, or scrolling lyrics or textual information of a program displayed in the LCD 5. In the multifunction button 3a, for example, an ON signal that instructs to start or stop reproduction can be input when a central button is pressed, and a control command (an instruction) for scrolling, e.g., an image or a character string displayed in the LCD 5 in a direction of a pressed button when any button in four directions (which are generally called “up, down, left, and right directions”) is pressed. Furthermore, the wireless network unit 43 and an antenna 1a that is used for wireless communication with the outside are provided at predetermined positions of the player 1. Incidentally, it is preferable for the antenna 1a to be provided at a portion using a non-metal material in members constituting the player 1, e.g., a portion on a side surface of the player 1 near a non-illustrated main power supply switch.

Meanwhile, since the hard disk unit (HDD) includes a motor, a relatively large power (a current value discharged from the battery 9 is large) is required at the time of activation. Therefore, in the apparatus (the portable media player) using the HDD 7, in order to reduce power consumption, a read operation and a stop operation that a given fixed amount of data is read out from the recording medium (the HDD 7) to be buffered in the RAM 23 and then driving of the HDD 7 is stopped are repeated. When the HDD 7 is a device that does not include a motor such as a flash-ROM or an SD memory card, since a reading speed from these devices is slower than that of the RAM, processing of reading a fixed amount of data to be buffered in the RAM 23 is carried out.

The player 1 can download a multimedia data file, e.g., an audio data file or a vide data file released to the public on a site on the Internet through the wireless network unit and store it in the HDD 7. Further, the player 1 can reproduce the stored data.

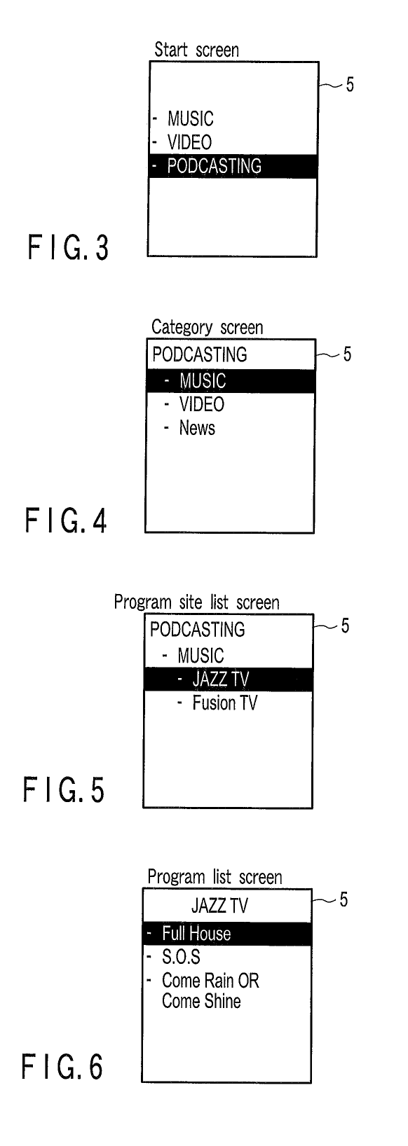

However, there are many sites (which will be referred to as program sites hereinafter) releasing audio data files and image data files to the public, and using the player 1 having no keyboard to access these sites is difficult. Thus, a manufacturer who sells the player 1 or a service company that has received a commission from this manufacturer opens a portal site providing a program site introducing service, and information of URL of the portable site is stored in the HDD 7 at the time of, e.g., shipment of the player 1. When a user selects podcasting in a start screen depicted in FIG. 3, a category screen is displayed as shown in FIG. 4. In FIG. 4, categories “MUSIC”, “VIDEO”, and “NEWS” are displayed, and URL of the portal site is embedded in each category. This data is stored as a top menu file in the HDD 7.

When the user selects a given category, data (a menu information file) of a MUSIC page in the portal site is acquired based on URL of the portal site in the HDD, and a program site list screen included in the MUSIC category is displayed on the LCD.

Further, when the user selects JAZZ TV from a page depicted in FIG. 5, a program list screen showing information of a multimedia data file provided by JAZZ TV is displayed in the LCD 5 as shown in FIG. 6. The program site like JAZZ TV distributes a list of provided multimedia data files in the form of metadata using the RSS format or the Atom format based on the XML language.

However, there are various formats of multimedia data files provided by the program site since a general computer is a target. In reality, recording formats of data files that can be reproduced by the player 1 are MP3, WMA, and WMV. That is, some of the data files provided by the program site cannot be reproduced by this apparatus.

Therefore, when a list included in data having the RSS format or the Atom format (which will be referred to as RSS [Atom] data hereinafter) provided by the program site is displayed in the LCD as it is, the list may include files having a recording format that cannot be reproduced by this apparatus. In this apparatus, files that can be reproduced by this apparatus alone are displayed in the LCD except files that cannot be reproduced by this apparatus from the list displayed in the LCD.

It is to be noted that some of multimedia data files cannot be reproduced even though they are the files in the reproducible recording format. A resolution of the LCD in this apparatus is VGA (320×240). Therefore, a vide data file having a resolution exceeding QVGA cannot be reproduced even though its recording format can be reproduced by this apparatus. Furthermore, a file that is recorded at a high bit rate cannot be reproduced because of a restriction in a throughput of production software even though a recording format of this file can be reproduced by this apparatus.

In this apparatus, a multimedia data file that cannot be reproduced because of a high resolution or a high bit rate is not displayed in the list even if it has a reproducible recording format.

A description will now be given as to a structure that displays in the LCD a file that can be reproduced by the apparatus from the list provided by the program site alone.

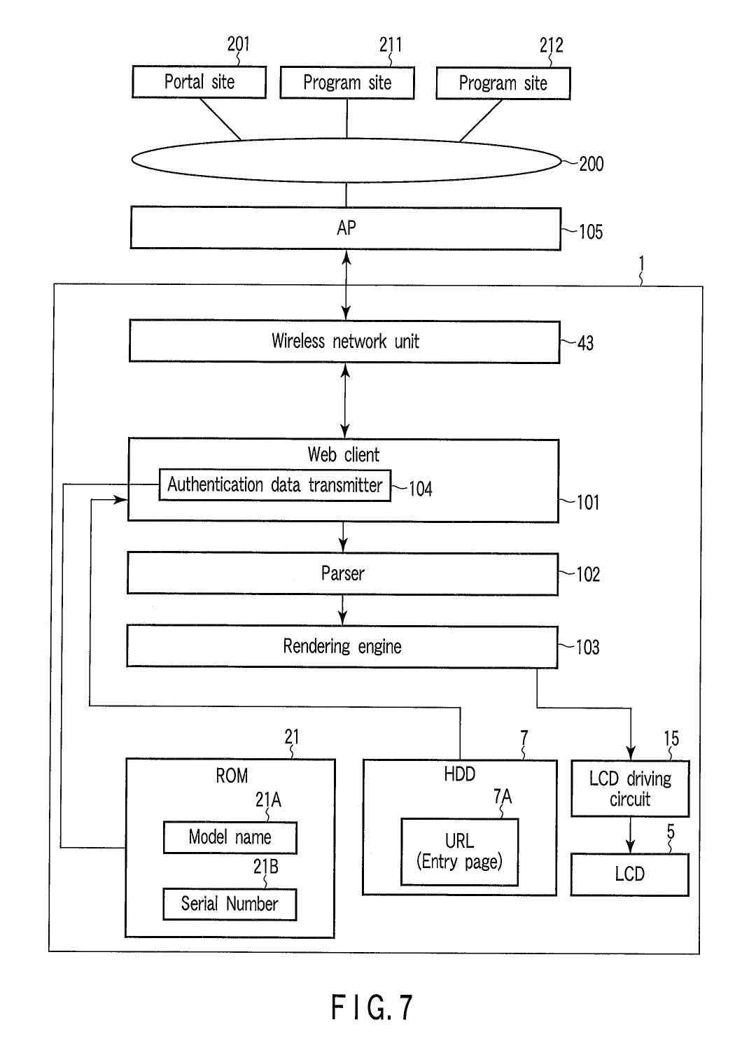

FIG. 7 is a view showing a structure concerning a podcasting function of the information processing apparatus according to an embodiment of the present invention.

As shown in FIG. 7, this apparatus has a web client 101, a parser 102, a rendering engine 103, an authentication data transmitter 104, a wireless network unit 43, a ROM 21, an HDD 7, an LCD driving circuit 15, and an LCD 5. It is to be noted that the web client 101, the parser 102, the rendering engine 103, and the authentication data transmitter 104 are programs executed by the CPU 11.

The web client 101 communicates (uses, e.g., HTTP) with a server (e.g., a Web server) to obtain information associated with a specified uniform resource identifier. The parser 102 has a function of analyzing the obtained information in accordance with its type (e.g., HTML, XHTML, XML, an image, or a text). Furthermore, the parser 102 has a function of deleting information of a multimedia data file that cannot be reproduced by this apparatus from RSS (Atom) data when the RSS (Atom) data is transmitted from program sites 211 and 212.

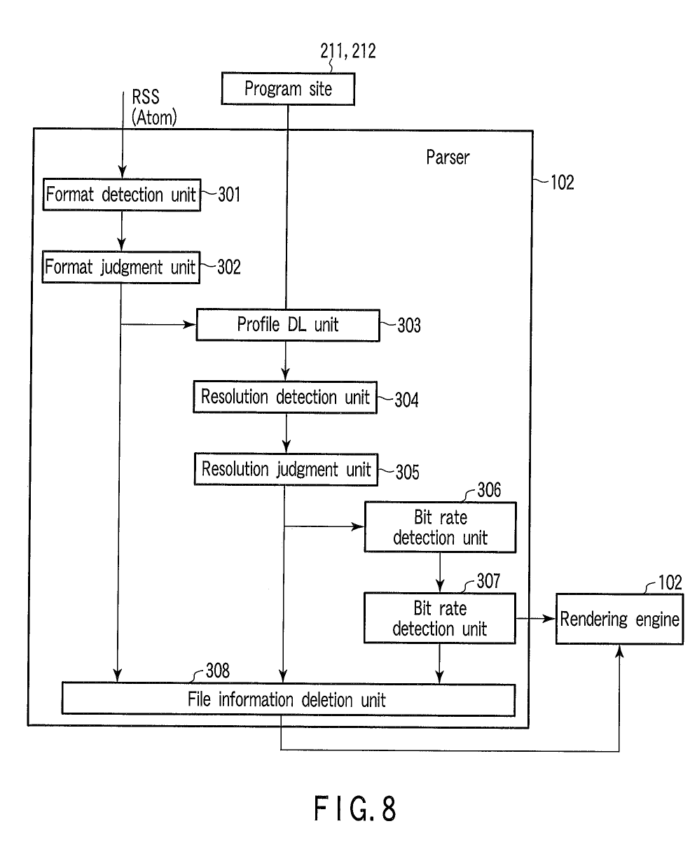

The function of deleting the information of the multimedia data file that cannot be reproduced by the parser 102 from the RSS (Atom) data will now be explained. FIG. 8 is a view showing a structure that deletes information of a multimedia data file that can be produced by the player 1 from the RSS (Atom) data.

As shown in FIG. 8, this structure has a format detection unit 301, a format judgment unit 302, a profile download (DL) unit 303, a resolution detection unit 304, a resolution judgment unit 305, a bit rate detection unit 306, a bit rate judgment unit 307, and a file information deletion unit 308.

The format detection unit 301 detects a recording format of each multimedia data file written in the RSS (Atom) data. A principle of a method of detecting a recording format of each multimedia data file will now be explained hereinafter.

First, data in the RSS format transmitted from the program sites 211 and 212 will be shown below.

```
        <?xml version=”1.0” encoding=”UTF-8”?>
    <rss version=”2.0”>
    <channel>
    <title>site name</title>
    <link>URL of a distribution website</link>
    <description>explanation about
podcasting</description>
    <language>language type</language>
    <item>
    <title>title of distribution data</title>
    <description>explanation about distribution
data</description>
    <pubDate>date and hour of distribution</pubDate>
    <enclosure url=”URL of distribution
data”length=”file size of distribution data”type=”MIME
type of distribution data”/>
    </item>
    </channel>
    </rss>
```

The above is a format of RSS. Information of a multimedia data file is written between “<item>” and “</item>”. When a plurality of multimedia data files are distributed, a combination of “<item>” and “</item>” is written in accordance with each multimedia data file, and information of each multimedia data file is written between “<item>” and “</item>”.

An enclosure element is sandwiched between “<” and “/>” following “</pubDate>”. A type attribute is written after “type=” in the enclosure element.

The type attribute is provided to write a recording format of distribution data. The type attribute is written as, e.g., “audio/mpeg”, “audio/WMA”, “audio/AAC”, “video/WMV”, or “video/mpeg4”.

Therefore, the format detection unit 301 can detect a recording format of each multimedia data file by extracting the type attribute from the space between “<item>” and “</item>” and seeing contents of the type attribute. It is to be noted that data in the Atom format likewise has the enclosure element and the type attribute in the enclosure element.

The format judgment unit 302 judges whether a recording format of the multimedia data file detected by the format detection unit 301 is a format that can be reproduced by the reproduction software. When it is determined that the format cannot be reproduced, the format judgment unit 302 informs the file information deletion unit 308. The file information deletion unit 308 deletes the information of the file determined to unreproducible from the RSS (Atom) data. That is, it selectively deletes data from “<item>” to </item>” from the RSS (Atom) data.

The profile DL unit 303 downloads from the program sites 211 and 212 data including a profile included the multimedia data file determined to be reproducible by the format judgment unit 302, and extracts the profile from the downloaded data. The profile includes information of a resolution at the time of reproduction and a bit rate. The profile DL unit 303 downloads data of 1 Kbyte from the head of the multimedia data file in order to download the data including the profile. The profile portion is present at the head of the multimedia data file, and its size is smaller than 1 Kbyte. Therefore, selectively downloading the data of 1 Kbyte from the head of the multimedia data file enables downloading the data including the profile.

The resolution detection unit 304 extracts information of a resolution from the profile extracted by the profile DL unit 303. Moreover, the resolution judgment unit 305 judges whether the extracted resolution is a resolution enabling display in the LCD 5. A resolution of the LCD 5 is VGA. Therefore, the resolution judgment unit 305 determines that the multimedia data file having a resolution larger than VGA cannot be reproduced. If it is determined that the file cannot be reproduced, the resolution judgment unit 305 informs the file information deletion unit 308. The file information deletion unit 308 deletes the information of the file determined to be unreproducible from the RSS (Atom) data.

The bit rate judgment unit 307 extracts the information of the bit rate of the multimedia data file determined to be reproducible by the resolution judgment unit 305 from the profile extracted by the profile DL unit 303.

Additionally, the bit rate judgment unit 307 judges whether the extracted bit rate is a bit rate enabling reproduction by the reproduction software. If it is determined that reproduction is impossible, the bit rate judgment unit 307 informs the file information deletion unit 308. The file information deletion unit 308 delete the information of the file determined to be unreproducible from the RSS (Atom) data.

With the above-explained structure, the information of the multimedia data file that cannot be reproduced by the player 1 can be deleted from the RSS (Atom) data by the structure in the parser 102 depicted in FIG. 7.

The rendering engine 103 is a program that performs calculation for actually displaying data written in a web page description language such as HTML or XML (RSS [Atom] data) in the screen based on an analysis result obtained by the parser 102.

The ROM 21 stores a model name 21A and a serial number 21B of a product. The HDD 7 stores URL 7A of a top page of a portal site 201.

When the apparatus 1 requests transmission of data, the portal site 201 requests the apparatus 1 to transmit the model name and the serial number in order to execute authentication processing. The authentication data transmitter 104 in the web client 104 reads the model name 21A and the serial number 21B from the ROM 21, and transmits the model name 21A and the serial number 21B to the portal site 201. The portal site 201 uses the model name 21A and the serial number 21B to execute authentication processing.

The wireless network unit 43 accesses the portal site 201 and the program sites 211 and 212 connected to a network 200 through an access point (AP) 105.

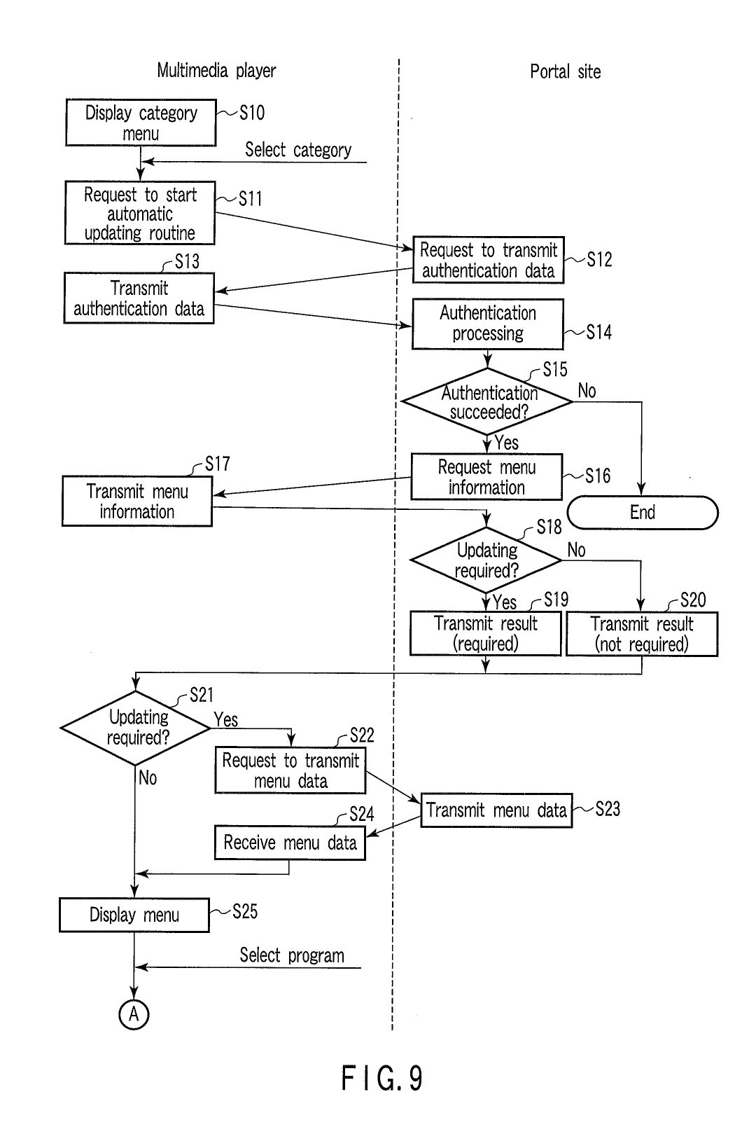

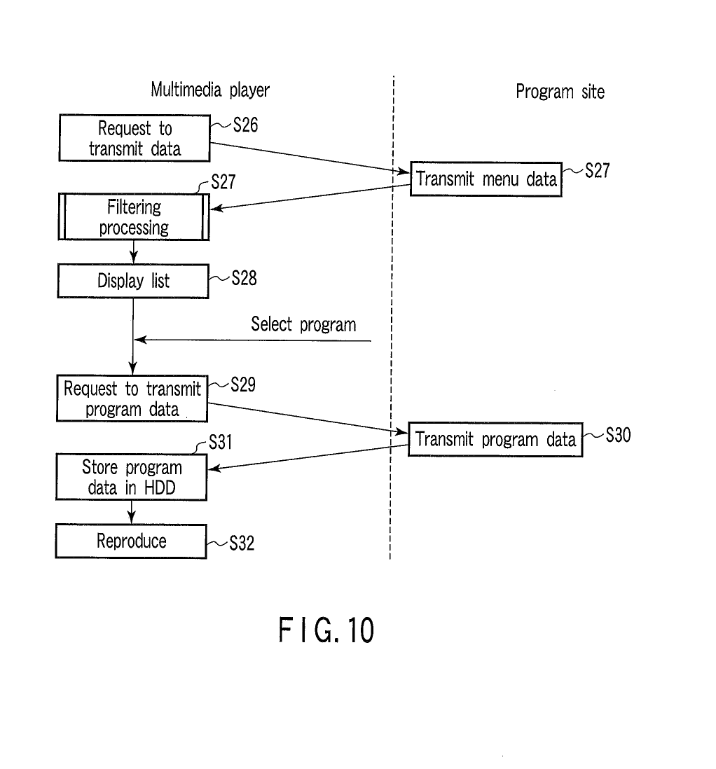

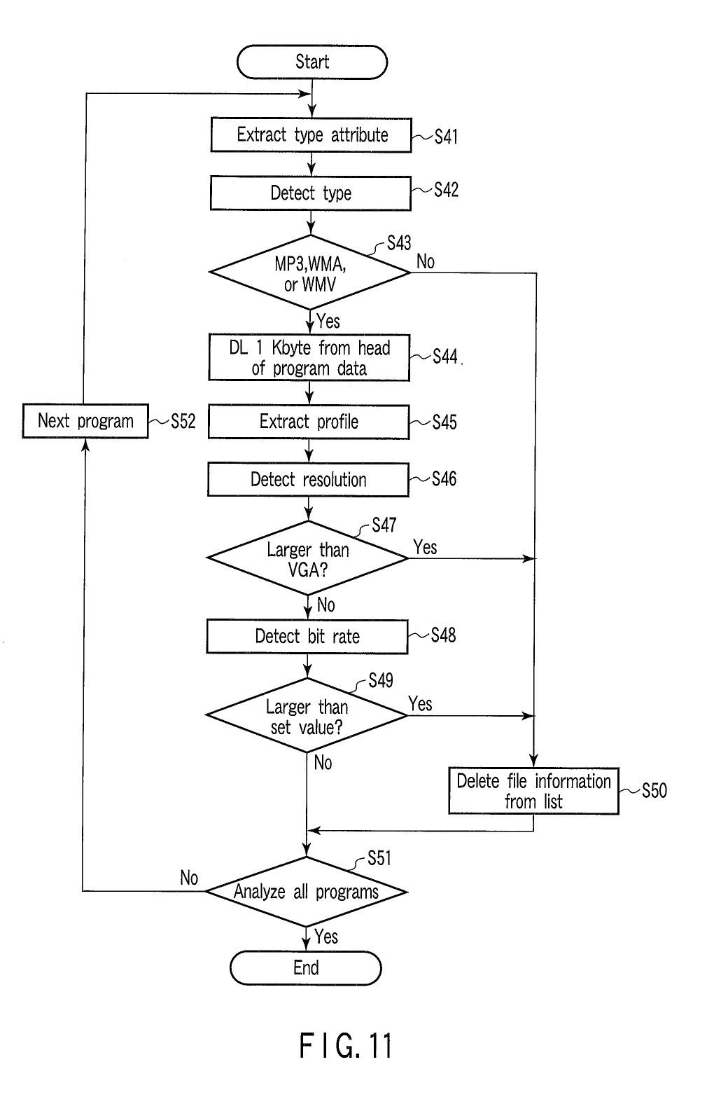

A description will now be given as to a procedure of processing from selection of a podcasting service by a user to download and reproduction of a multimedia data file with reference to flowcharts depicted in FIGS. 9 to 11.

When display in the LCD 5 is in a state depicted in FIG. 3 and a user selects “PODCASTING”, a category menu depicted in FIG. 4 is displayed in the LCD 5 (step S10). When the user selects “MUSIC” from the category menu, the web client 101 transmits a request to ask the portal site 201 about whether a “MUSIC” menu cached in the HDD 7 is to be updated (step S12).

The portal site 201 requests transmission of authentication data (a model name and a serial number) required for authentication processing of confirming whether the device that has transmitted the request is the legitimate multimedia player 1 (step S12).

The authentication data transmitter 104 transmits the authentication data (the model name and the serial number) to the portal site 201 in response to the request (step S13). The portal site 201 that has received the authentication data executes the authentication processing (step S14). When the authentication has succeeded (Yes in step S15), the portal site 201 requests transmission of version information of a top menu file required to judge whether the top menu file must be updated (step S16). The version information of the top file menu is information allowing confirmation of, e.g., a date or a version of menu data such as a time stamp or version information of the top menu file cached in the HDD 7.

Since the model name is used as the authentication data, the authentication enables the portal site 201 to judge a connected model. Therefore, the top file menu can be changed based on the connected model.

When the authentication has failed (No in step S15), it is determined that the device that has transmitted the request in step S11 is not the legitimate multimedia player 1, and the portal site 201 terminates the processing.

The web client 101 of the multimedia player 1 that has requested transmission of the menu information transmits the menu information to the portal site 201 (step S17). The portal site 201 compares the received menu information with information of the menu data included in the portal site 201 to judge whether updating is required (step S18).

When it is determined that updating is required (Yes in step S18), the portal site 201 informs the multimedia player 1 that updating is required (step S19). When it is determined that updating is not required (Yes in step S18), the portal site 201 informs the multimedia player 1 that updating is not required (step S20).

After step S19 or step S20, the multimedia player 1 that has been informed of a result indicating necessity for updating judges whether updating the menu data is required from the reported result (step S21).

When it is determined that updating is required (Yes in step S21), the web client 101 requests the portal site 201 to transmit data of the “MUSIC” menu (step S22). The portal site 201 transmits the data of the latest “MUSIC” menu to the multimedia player 1 (step S23). Upon receiving the menu data, the web client 101 stores the received data in the HDD 7 as a cache (step S24).

When it is determined that updating is not required (No in step S21), or after the new menu data is stored in the HDD 7 as a cache, the cache of the menu data stored in the HDD 7 is utilized to display such a program list menu as shown in FIG. 5 (step S25).

When the user selects a program, the web client 101 requests a program site (JAZZ TV) to transmits RSS (Atom) data (step S26). The program site (JAZZ TV) transmits the RSS (Atom) data to the multimedia player 1. Upon receiving the RSS (Atom) data, the web client 101 transfers the data to the parser 102. The parser 102 executes filtering processing (step S27).

The filtering processing will now be explained with reference to a flowchart of FIG. 11. The format detection unit 301 extracts a type attribute from information of a given multimedia data file included in the RSS (Atom) data (step S41). The format detection unit 301 detects the extracted type attribute, and informs the format judgment unit 302 of a detection result (step S42). The format judgment unit 302 judges whether the reported recording format is a format that can be reproduced by the player 1 (MP3, WMA, or WMV) (step S43). If it is determined that reproduction is impossible (No in step S43), the format judgment unit 302 informs the file information deletion unit 308 of the information of the multimedia data file, and the file information deletion unit 308 deletes the information of the multimedia data file reported from the RSS (Atom) data (step S50).

If it is determine that reproduction is possible (Yes in step S43), the format judgment unit 302 informs the profile DL unit 303 of the information of the multimedia data file. The profile DL unit 303 that has been informed of the information selectively downloads data of 1 Kbyte from the head of the multimedia data file including a profile from the program site (JAZZ TV) (step S44). Further, the profile DL unit 303 extracts the profile from the downloaded data, and informs the resolution detection unit 304 of the profile and the information of the multimedia data file (step S45).

The resolution detection unit 304 detects information of a resolution from the profile, and informs the resolution judgment unit 305 of the information of the resolution and the information of the multimedia data file (step S46). The resolution judgment unit 305 judges whether the detection resolution is higher than a resolution (VGA) enabling display in the LCD 5 (step S47).

When it is determined that the detected resolution is higher than VGA (Yes in step S47), the resolution judgment unit 305 informs the file information deletion unit 308 of the information of the multimedia data file, and the file information deletion unit 308 deletes the reported information of the multimedia data file from the RSS (Atom) data (step S50).

When it is determined that the detected resolution is not higher than VGA (No in step S47), the resolution judgment unit 305 informs the bit rate detection unit 306 of the profile and the information of the multimedia data file. The bit rate detection unit 306 detects information of a bit rate from the profile, and informs the bit rate judgment unit 307 of the information of the bit rate and the information of the multimedia data file (step S48). The bit rate judgment unit 307 judges whether the detected bit rate is higher than a set value in order to judge whether reproduction can be performed by reproduction software (step S49). When it is determined that the detected bit rate is higher than the set value (Yes in step S49), the bit rate judgment unit 307 informs the file information deletion unit 308 of the information of the multimedia data file, and the file information deletion unit 308 deletes the reported information of the multimedia data file from the RSS (Atom) data (step S50).

After the processing in step S50, or when it is determined that the bit rate is not higher than the set value in step S49 (No in step S49), the parser 102 judges whether analysis has been executed with respect to all programs (multimedia data files) written in the RSS (Atom) data (step S51).

When it is determined that analysis has not been executed (No in step S51), the processing starting from step S41 is performed to execute analysis with respect to the next program. When it is determined that analysis has been executed (Yes in step S51), the filtering processing is terminated.

After end of the filtering processing, the parser 102 transfers the RSS (Atom) data subjected to the filtering operation to the rendering engine 103. The rendering engine 103 displays, e.g., such a program list menu as depicted in FIG. 6 based on the RSS (Atom) data (step S28).

When the user selects a program, the web client 101 requests the program site to transmit data (a multimedia data file) of the program (step S29). The program site transmits the multimedia data file to the player 1 (step S30).

The web client 101 stores the received multimedia data file in the HDD (step S31). When downloading the multimedia file is terminated, the player 1 reproduces the file.

As explained above, when the user uses the site that provides podcasting for display, information of the file that can be reproduced by the player 1 alone can be selectively displayed. As a result, the user does not erroneously download the file that cannot be reproduced by the player 1. Consequently, the operability of the user is improved.

It is to be noted that making reference to a length attribute in the enclosure element enables detecting a size of the multimedia data file, thereby filtering information of the multimedia data file having a large file size.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a main body;
a display unit provided in the main body;
an audio output unit provided in the main body;
reproducing unit configured to reproduce a multimedia data file having a specific recording format and output a reproduction signal to at least one of the display unit and the audio output unit;
a communication circuit that achieves connection with a network;
acquiring unit configured to acquire metadata in which one or more pieces of meta-information including an address attribute to download the multimedia data file from a program site are written by using the communication circuit;
format detecting unit configured to detect a recording format of each multimedia data file written in each piece of meta-information written in the metadata;
first judging unit configured to judge whether the multimedia data file written in each piece of meta-information written in the metadata is reproducible by the reproducing unit based on a detection result obtained by the format detecting unit;
deleting unit configured to generate new metadata obtained by deleting the meta-information having the multimedia data file determined to be unreproducible by the first judgment unit written therein from the metadata;
display unit configured to display a list of the multimedia data files written in the meta-information included in the new metadata in the display unit;
an operation button configured to select the multimedia data file that is downloaded to the main body based on information of the multimedia data file displayed in the display unit; and
downloading unit configured to download multimedia data file selected by the operation button by using the communication circuit.

2. The apparatus according to claim 1, wherein the metadata is written in an RSS format or an Atom format based on the XML language.

3. The apparatus according to claim 2, wherein the format detecting unit detect a recording format of the multimedia data file by reference to a type attribute in an enclosure element of the meta-information written in the RSS format or the Atom format.

4. The apparatus according to claim 1, further comprising second judging unit configured to judge whether a resolution when reproducing each multimedia data file determined to be reproducible by the first judging unit is higher than a resolution of the display unit,
wherein meta-information having the multimedia data file determined to have the high resolution by the second judging unit written therein is deleted in the new metadata generated by the deleting unit.

5. The apparatus according to claim 4, further comprising:
selective downloading unit configured to selectively download data having a predetermined size from the head of the multimedia data file in order to obtain a profile of the multimedia data file; and
resolution detecting unit configured to detect a resolution of the multimedia data file by making reference to the profile of the multimedia data file included in the downloaded file.

6. The apparatus according to claim 1, further comprising third judging unit configured to judge whether a bit rate of each multimedia data file determined to be reproducible by the first judging unit is higher than a bit rate enabling reproduction by the reproducing unit,
wherein meta-information having the multimedia data file determined to have a high bit rate by the third judging unit written therein is deleted in the new metadata generated by the deleting unit.

7. The apparatus according to claim 6, comprising:
selective downloading unit configured to selectively download data having a predetermined size from the head of the multimedia data file in order to obtain a profile of the multimedia data file; and
bit-rate detecting unit configured to detect a bit rate of the multimedia data file by reference to the profile of the multimedia data file included in the downloaded file.

8. The apparatus according to claim 1, wherein the communication circuit is connected with the network based on wireless communication.

9. The apparatus according to claim 1, further comprising a storage device configured to store address information of a site that releases to the public one or more pieces of information of program sites where the metadata is released to the public.

10. A control method for an information processing apparatus comprising: a display unit provided in a main body; an audio output unit provided in the main body; and reproducing unit configured to reproduce a multimedia data file having a specific recording format and output a reproduction signal to at least one of the display unit and the audio output unit, the method comprising:
acquiring metadata in which one or more pieces of meta-information including an address attribute required to download the multimedia data file from a program site are written by using a built-in communication circuit in the main body;
detecting a recording format of each multimedia data file written in each piece of meta-information written in the metadata;
judging whether the multimedia data file written in each piece of meta-information written in the metadata is reproducible by the reproducing unit based on a recording format detection result;
deleting the meta-information having the multimedia data file determined to be unreproducible written therein from the metadata to generate new metadata;
displaying a list of the multimedia data files written in the meta-information included in the new metadata in the display unit; and
downloading the selected contents by using the communication circuit.

11. The method according to claim 10, wherein the metadata is written in an RSS format or an Atom format based on the XML language.

12. The method according to claim 11, wherein the detecting unit detects a recording format of the multimedia data file by reference to a type attribute in an enclosure element of the meta-information written in the RSS format or the Atom format.

13. The method according to one of claims 10, wherein whether a resolution when reproducing each multimedia data file determined to be reproducible is higher than a resolution of the display unit is judged, and
the meta-information having the multimedia data file determined to have the high resolution is deleted in the new metadata.

14. The method according to claim 13, wherein data having a predetermined size is selectively downloaded from the head of the multimedia data file in order to obtain a profile of the multimedia data file, and
a resolution of the multimedia data file is detected by making reference to the profile of the multimedia data file included in the downloaded file.

15. The method according to one of claims 10, wherein whether a bit rate of each multimedia data file determined to be reproducible is higher than a bit rate enabling reproduction by the reproducing unit is judged, and
the meta-information having the multimedia data file determined to have the high bit rate written therein is deleted in the new metadata.

16. The method according to claim 15, wherein data having a predetermined size is selectively downloaded from the head of the multimedia data file in order to obtain a profile of the multimedia data file, and
a bit rate of the multimedia data file is detected by making reference to the profile of the multimedia data file included in the downloaded file.

17. The method according to one of claims 10, wherein the communication circuit is connected with the network based on wireless communication.

18. The method according to one of claims 10, further comprising a storage device that stores address information of a site that releases to the public one or more pieces of information of program sites where the metadata is released to the public.
